(19) United States
(12) Patent Application Publication
(10) Pub. No.: US 2007/0193089 A1
(43) Pub. Date: Aug. 23, 2007

(54) Light emitting diode symbol block apparatus and method for forming non-pixelated signs

(76) Inventor: Gus Hadaya, San Diego, CA (US)

Correspondence Address: DALINA LAW GROUP, P.C., 7910 IVANHOE AVE. #325, LA JOLLA, CA, 92037, US

(21) Appl. No.: 11/512,760

(22) Filed: Aug. 29, 2006

Related U.S. Application Data
(60) Provisional application No. 60/712,270, filed on Aug. 29, 2005.

(51) Int. Cl. G09F 13/22

(52) U.S. Cl. 40/544

(57) ABSTRACT

Light emitting diode (LED) signs made from blocks comprising LEDs that provide illuminated symbols such as letters, numbers, icons, shapes wherein the individual LEDs are not discernable as discrete dots. The signs may be used for commercial applications or any other application. A user may make a custom sign by ordering the symbols for the desired sign in the desired size and font. Each block comprises symbol(s) that may be constructed on a circuit board using LEDs. The block may comprise a background having a complementary color with respect to the LEDs. The blocks may comprise or couple with tracks or rails or other mechanisms such as wire that allow for low voltage power to illuminate the blocks symbols. An acrylic face may be mounted as the face of the circuit board to diffuse light so that the individual LEDs are not visible as individual dots, but rather as continuous lines.

### RELATED APPLICATION DATA

This application claims benefit of U.S. Provisional Application No. 60/712,270 entitled “LIGHT EMITTING DIODE SUMBOL BLOCK APPARATUS AND METHOD FOR FORMING NON-PIXELATED SIGNS” filed Aug. 29, 2005, the content of which is hereby incorporated herein by reference.

### BACKGROUND OF THE INVENTION

1. Field of the Invention

Embodiments of the invention described herein pertain to the field of signs. More particularly, but not by way of limitation, one or more embodiments of the invention enable light emitting diode (LED) blocks to form signs wherein the individual LEDs are not discernable as discrete dots.

2. Description of the Related Art

Existing types of illuminated signs include neon signs, neon letters, regular cut letters with external illumination, back lit signs, edge lit signs and light emitting diode (LED) signs. Each of these types of sign have limitations with respect to embodiments of the present invention.

Neon signs are bright and may be made into any form and color. The ability to form continuous lines and custom letters with neon signs make the visual display of a neon sign desirable. However, neon signs are costly to create since they must be custom built by skilled artists that are trained to heat and bend glass. When a neon sign or part of a neon sign is broken, the sign may take many business days or weeks to rebuild depending on the workload of the third party that is hired to fix the sign. Since neon signs are delicate they are susceptible to vandalism. Gas leaks make for signs that are partially illuminated and this tarnishes the image of an establishment during the period that the sign is malfunctioning.

Externally illuminated, back lit and edge lit signs generally require high power and are costly to operate over long periods of time. For example, due to the fact that these types of lights use incandescent bulbs, they are also costly to maintain since these type of illumination sources have limited life times and require more energy.

LED signs have many advantages over the other types of signs, however to date there are no known LED signs that form continuous lines as are formed with neon signs for example. Known LED signs are formed into fixed size dot matrix configurations having clearly separated dots. These types of signs use low power, generally 12 and 24-volt sources. Current LED signs do not allow for continuous lines to be constructed in ways that neon signs allow for. Generally, LED signs are configured into dot matrix configurations so that they may be used as ticker signs that allow for messages to be streamed across the sign. Other LED illumination sources include rope-like lines that have an acrylic jacket around them with LEDs inside to create a flexible light source, however these lines still are made of up individual dots. There is no known LED based device that allows for continuous lines to be formed without pixelation. In addition, there are known LED based sign systems that allow for end users to order symbols such as letters, numbers, icons or shapes and can combine them into customizable LED signs comprising continuous lines.

For at least the limitations described above there is a need for a light emitting diode symbol block apparatus and methods for forming non-pixelated signs that allow users to combine symbols such as letters, numbers, icons or shapes to create desired signs.

### BRIEF SUMMARY OF THE INVENTION

One or more embodiments of the invention enable light emitting diode (LED) symbol blocks to be formed into non-pixelated signs. Non-pixelated means that the individual LEDs are not discernable to the human eye as separate dots, but instead form lines such as are found in neon signs for example. Blocks may be constructed from circuit boards comprising LEDs that when energized, form symbols such as letters, numbers, icons, shapes or any other form of written communication in any language. After the individual symbol(s) desired for a sign are grouped into a message to display, the sign may coupled to a power source and illuminated, thereafter displaying the desired message. The sign may be used indoors or outdoors for advertising, identification, or for any other purpose. A user without any knowledge of custom sign construction may make sophisticated custom signs by ordering the symbols such as letters, numbers, icons or shapes necessary for the desired sign in the desired size and font and then grouping the symbols into a message to display on a sign. Each symbol comprising at least one letter, number, icon or shape may be constructed on a circuit board that may comprise or couple with tracks or rails or other mechanisms such as wire that allow for low voltage power to illuminate the symbol. In one embodiment of the invention, symbols are implemented using on COB (chip on board) technology circuitry with an acrylic face that diffuses the light so that the individual LEDs are not visible as individual dots, but rather as continuous lines. Any available LED color or any combination of colors may be used for an individual symbol. In addition, the LEDs can be programmed to change color and/or color temperature and brightness.

Signs may be modified by removing one symbol and adding another symbol to the sign. This is not possible with neon signs that are bent into shape and never modified. A sign thus configured may be hung by a chain or cable or any other support mechanism and can be mounted on any surface. An acrylic cast face with a color background may be used for a given letter so as to make the letter more aesthetically pleasing. Any material that diffuses light in order to hide the gaps between the individual LEDs may be used as a diffuser face in one or more embodiments of the invention.

The blocks comprising symbols are lightweight, easily connected to a power source and allow for an end user to readily create a sign without requiring a third party to custom manufacture a sign. In addition, since low power is used instead of 120 volt power for conventional signs (or internal 12,000 volts for neon), there are no safety issues with allowing the user to configure and energize the sign. This allows for end users to create their own custom signs without knowledge of glass bending for example or other manufacturing techniques that have heretofore been required to make custom signs. In addition, LED blocks have extremely long life, typically two orders of magnitude higher than incandescent bulbs and up to 100,000 hours. LED blocks are also shock resistant and capable of handling the stress of vibration and heat. LED blocks are cheaper to ship since they require far less padding during shipping than neon lights for example. Also, embodiments of the invention allow for extremely low profile signs to be built, for example less than one millimeter in thickness. Embodiments of the invention therefore have distinct advantage in longevity, energy efficiency, price (both versus a custom neon sign for example and also amortized over the expected lifetime due to lower power usage), weight, profile, service, brightness, flexibility, quick construction time, and safety.

Each LED making up a symbol may be surface mounted on a circuit board to form a line or to fill part of the background for example. The background may comprise a complementary color with respect to the LED, but this is not required. In one or more embodiments of the invention, a layer of acrylic cast is applied to the surface to act as a diffuser for the LED output source hence creating a complete form of each symbol by filling the gap between the LED chips with diffusing material. For low profile applications, Chip On Board technology (COB) mounting allows for LEDs to be bonded directly to boards and/or substrates with wire bond connections made from board to LED. This allows for extremely thin implementations that no other sign technology can approach.

A thicker layer of Acrylic on the face each of the symbols or a complete clear acrylic facing on the entire sign may be used to provide protection from the outdoor elements. The individual circuit boards may be shaped in the form abstract shapes, or arrow or any form of a decorative design that could be used for lighting or novelty items. There is no requirement that the blocks forming a sign be of rectangular shape or connect to each other for that matter since each block may obtain power from a track, rail, pair of wires or any other method.

Embodiments of blocks that make up a sign may comprise rigid or flexible circuit boards. Each block may be flat or may be curved or twisted in three-dimensions as long as the diffusing face is configured in the same manner to render the individual LEDs as continuous lines where intended in each symbol.

Circuit boards implementing blocks in one or more embodiments of the invention may comprise logic that governs the order in which individual LEDs comprising a symbol are fired. This for example may allow for traveling snake patterns or flashing patterns, or randomized patterns or any other pattern such as horizontal or vertical rolling waves to be used in the illumination of the LEDs. The circuit board may also comprise logic to perform effects include three-dimensional effects, sparkle, prismatic or geometric effects. In addition, the circuit boards may comprise small switches that allow for a block to be numbered which allows for on board logic on the circuit board to determine when to perform a special effect in relation to other cards for example. By pulsing small voltage signals onto the power lines coupled to each card, or by using wireless technologies such as Bluetooth, an external computing element for example may illuminate the symbols on each block in time order. This allows for sequencing through the characters in a sign, or flashing the characters one after another in rapid succession or random order. By coupling the sign to a communication interface, the sign may be programmed for illumination order, pattern or sequence remotely, such as over the Internet and changed from a corporate headquarter for example.

Each block may also comprise more than one symbol and therefore may comprise addresses for each symbol that a locally coupled or remotely connecting computer may use to illuminate individual symbols on a given block independently.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an embodiment of a sign formed from individual LED blocks comprising letters.

FIG. 2 illustrates a block comprising a symbol, in this case the letter “D”.

FIG. 3 illustrates a layout wherein the individual blocks are shown as rectangles.

FIG. 4 illustrates a sign that has been modified by a user to include more information with respect to the sign shown in FIG. 3.

FIG. 5 for example shows a rotating sign embodiment wherein blocks may be flat or curved.

FIG. 6 illustrates a flow chart detailing a method for using an embodiment of the invention.

FIG. 7 illustrates a method showing another embodiment of the invention.

### DETAILED DESCRIPTION

A light emitting diode symbol block apparatus and method for forming non-pixelated signs will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the fill scope of any equivalents, are what define the metes and bounds of the invention.

One or more embodiments of the invention enable light emitting diode (LED) symbol blocks to be formed into non-pixelated signs. Non-pixelated means that the individual LEDs are not discernable to the human eye as separate dots, but instead form lines such as are found in neon signs for example. Blocks may be constructed from circuit boards comprising LEDs that when energized, form symbols such as letters, numbers, icons, shapes or any other form of written communication in any language. After the individual symbol(s) desired for a sign are grouped into a message to display, the sign may coupled to a power source and illuminated, thereafter displaying the desired message. The sign may be used indoors or outdoors for advertising, identification, or for any other purpose. A user without any knowledge of custom sign construction may make sophisticated custom signs by ordering the symbols such as letters, numbers, icons or shapes necessary for the desired sign in the desired size and font and grouping the symbols into a message to display on a sign. Each symbol comprising at least one letter, number, icon or shape may be constructed on a circuit board that may comprise or couple with tracks or rails or other mechanisms such as wire that allow for low voltage power to illuminate the symbol. In one embodiment of the invention, symbols are implemented using COB (chip on board) technology circuitry with an acrylic face that diffuses the light so that the individual LEDs are not visible as individual dots, but rather as continuous lines. Any available LED color or any combination of colors may be used for an individual symbol. In addition, the LEDs can be programmed to change color and/or color temperature and brightness.

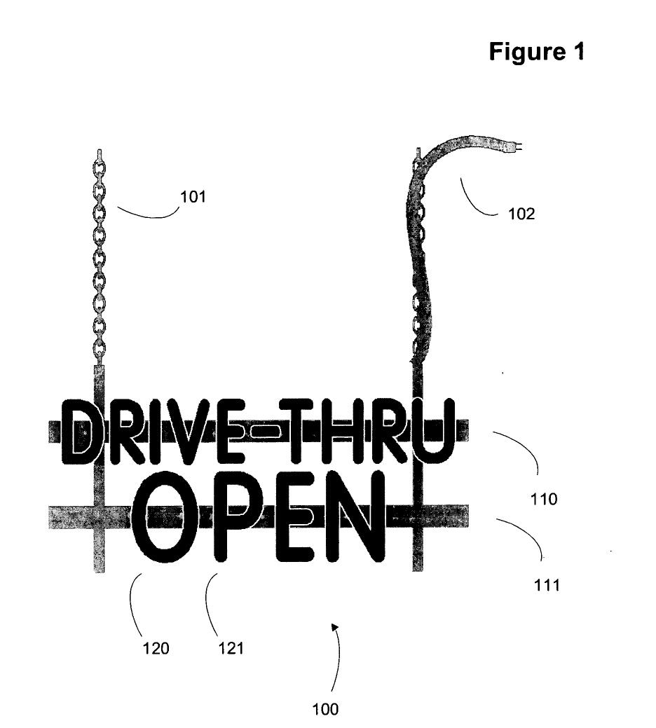

FIG. 1 illustrates an embodiment of sign 100 formed from individual LED blocks comprising letters, for example letter 120 “O” and letter 121 “P”. Optional mounting chain 101 is used to optionally secure sign 100 in a hanging position. Power chord 102 may be a low voltage chord running from a transformer for example to power sign 100. Each of the letters comprising the sign including the dash character between the words “Drive” and “Thru” in this embodiment are separate blocks. A dotted “i” for example has two separate portions, but may be considered one symbol. Blocks comprising more than one symbol are in keeping with the spirit of the invention. Power track 110 and 111 behind the letters are used to supply the individual blocks with power. Any method of coupling blocks to track 110 and 111 is in keeping with the spirit of the invention.

The blocks comprising symbols are lightweight, easily connected to a power source and allow for an end user to readily create a sign without requiring a third party to custom manufacture a sign. In addition, since low power is used instead of 120 volt power for conventional signs (or internal 12,000 volts for neon), there are no safety issues with allowing the user to configure and energize the sign. Power track 110 for example may comprise parallel lines wherein one line comprises a ground line and another line comprises a voltage offset from ground. A block such as block 120 in this example may be clipped on power track 111. Block 120 may be coupled to power track 111 by a magnet or coupled in any other manner as long as a voltage and ground source are configured to drive the LEDs in the block to provide illumination. By allowing users to readily and safely add or replace blocks, users can create, modify and maintain their own custom signs without knowledge of glass bending, for example, or other manufacturing techniques that have heretofore been required to make custom signs. In addition, LED blocks have extremely long life, typically two orders of magnitude higher than incandescent bulbs and up to 100,000 hours. LED blocks are also shock resistant and capable of handling the stress of vibration and heat. LED blocks are cheaper to ship since they require far less padding during shipping than neon lights for example. Also, embodiments of the invention allow for extremely low profile signs to be built, for example less than one millimeter in thickness. Embodiments of the invention may readily be placed into locations where neon signs are too thick to be utilized. Embodiments of the invention therefore have distinct advantage in longevity, energy efficiency, price (both versus a custom neon sign for example and also amortized over the expected lifetime due to lower power usage), weight, profile, service, brightness, flexibility, quick construction time, and safety. In terms of energy efficiency, over a 5 year period for ten stores each having a 10 square foot sign, the energy savings per year is approximately $900 while the maintenance reduction over the same period is at least $600.

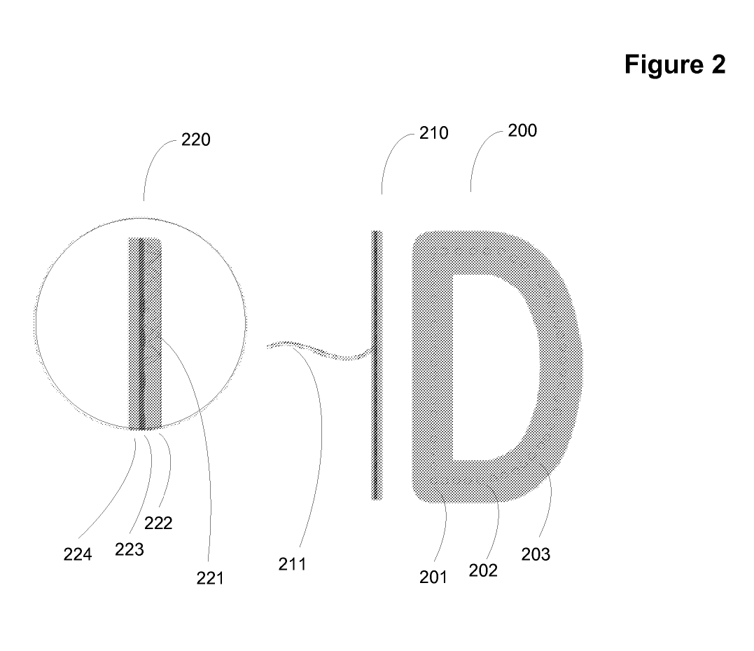

FIG. 2 shows block 200 comprising a symbol, in this case the letter “D”. Each LED making up a symbol such as LEDs 201, 202 or 203 may be surface mounted to form a line or to fill part of the background for example. In this case the LEDs form the outline of the letter “D”. Side view 210 of block 200 shows the extremely thin profile when surface mounted LEDs are used on a circuit board used to implement a block. Power wires 211 are one method of coupling power to a block, other methods for coupling power comprise tracks, rails or other interconnects generally on the non-illuminating side of block 200, although top, bottom, side or face coupling may be utilized. Blowup 220 of side view 210 shows diffuser 222, LED layer 223 and circuit board 224. In addition, light rays bouncing off of the surface of diffuser 222 are shown interacting with a background color painted on the surface of circuit board 224 in between and around each LED as shown in block 200. The background may comprise a complementary color with respect to the LED, but this is not required. In one or more embodiments of the invention, a layer of acrylic cast is applied to the surface to act as diffuser 222 hence creating a complete form of each symbol by filling the gap between the LED chips with diffusing material. For low profile applications, Chip On Board technology (COB) mounting allows for LEDs to be bonded directly to boards and/or substrates with wire bond connections made from board to LED. This allows for extremely thin implementations that no other sign technology can approach as per side view 210. The block may comprise only the portion of the symbol that will illuminate or may comprise a larger area with portions of the block that do not illuminate and are not subject to the diffusion of light rays, thereby limiting the width of the illuminated symbol.

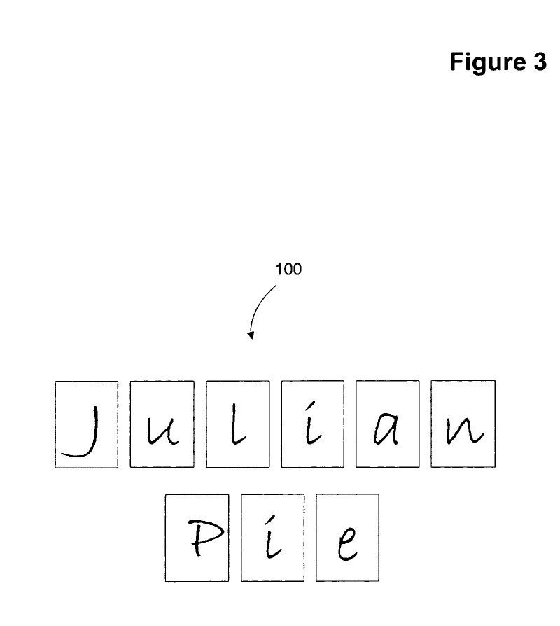

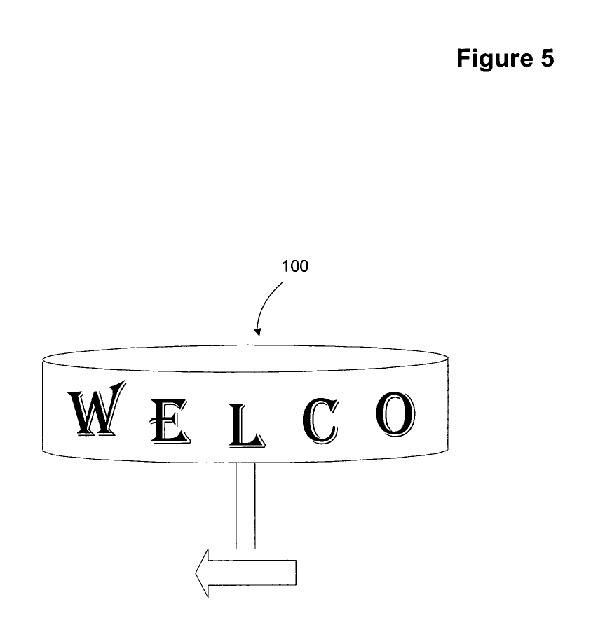

A thicker layer of Acrylic on the face of the individual symbols, or a complete clear acrylic facing on the entire sign may be used to provide protection from the outdoor elements. The individual circuit boards may be shaped in the form of abstract shapes, or arrow or any form of a decorative design that could be used for lighting or novelty items. There is no requirement that the blocks forming a sign be of rectangular shape or connect to each other for that matter since each block may obtain power from a track, rail, pair of wires or any other method. FIG. 3 shows a layout wherein the individual blocks are shown as rectangles although the blocks may or may not be rectangular in one or more embodiments of the invention as the block may simply comprise the shape of the underlying symbol. Any font or font size or font weight may be utilized. Embodiments of blocks that make up a sign may comprise stiff or flexible circuit boards. Each block may be flat or may be curved or twisted in three-dimensions as long as the diffusing face is configured in the same manner to render the individual LEDs as continuous lines where intended in each symbol. FIG. 5 for example shows a rotating sign comprising blocks showing a message “WELCOME” that is rotating into view as per the direction specified by the arrow beneath the axle upon which the sign rotates.

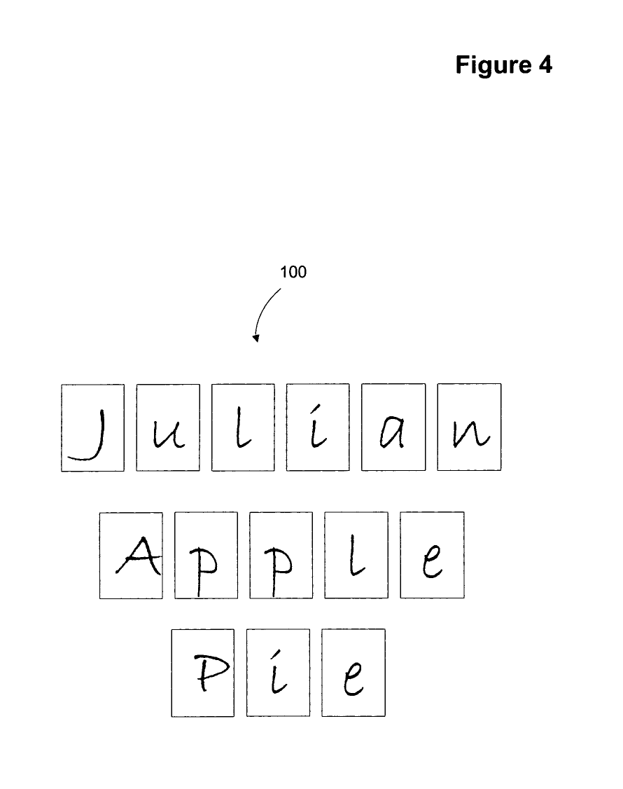

Signs may be modified by removing one symbol and adding another symbol to the sign. FIG. 4 for example shows a sign that has been modified to include more information with respect to the sign shown in FIG. 3. This is not possible with neon signs that are bent into shape and never modified. A sign thus configured may be hung by a chain or cable or any other support mechanism and such as individually mounting each block and each block can be mounted on any surface. An acrylic cast face with a color background may be used for a given symbol so as to make the letter more aesthetically pleasing. Any material that diffuses light in order to hide the gaps between the individual LEDs may be used as a diffuser face in one or more embodiments of the invention.

Circuit boards implementing blocks in one or more embodiments of the invention may comprise logic that governs the order in which individual LEDs comprising a symbol are fired. This for example may allow for traveling snake patterns or flashing patterns, or randomized patterns or any other pattern such as horizontal or vertical rolling waves to be used in the illumination of the LEDs. The circuit board may also comprise logic to perform effects include three-dimensional effects, sparkle, prismatic or geometric effects. In addition, the circuit boards may comprise small switches that allow for a block to be numbered which allows for on board logic on the circuit board to determine when to perform a special effect in relation to other cards for example. By pulsing small voltage signals onto the power lines coupled to each card, or by using wireless technologies such as Bluetooth, an external computing element for example may illuminate the symbols on each block in time order. With respect to FIG. 3 for example, if the block comprising “J” is set to “one” and the block immediate to the right comprising “u” is set to “two”, then the order in which the blocks illuminate is from left to right. This allows for sequencing through the characters in a sign, or flashing the characters one after another in rapid succession or random order. By coupling the sign to a wireless interface, the sign may be programmed for illumination order, pattern or sequence over the Internet and changed from a corporate headquarter for example.

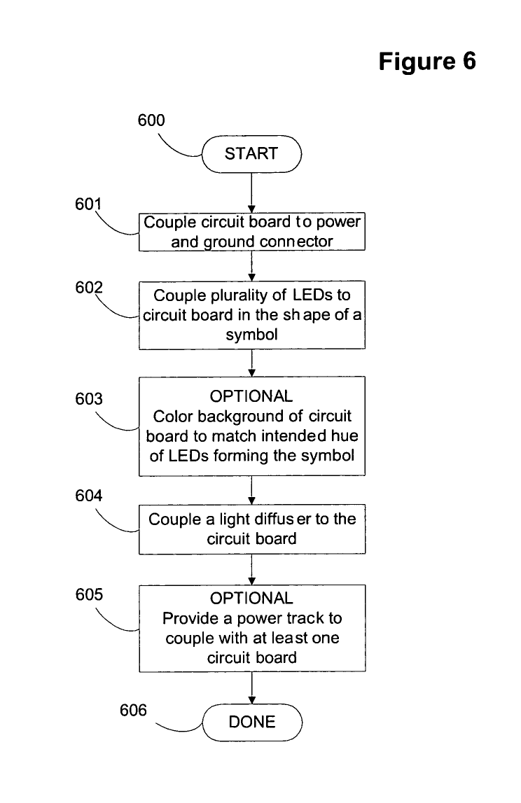

FIG. 6 illustrates a flow chart detailing a method for using an embodiment of the invention. As shown in FIG. 6, processing start at step 600 and in step 601, a circuit board is coupled to a power source and a ground connector. In step 602, a plurality of LEDs are coupled to a circuit board in the shape of a symbol or any desired character. In step 603, which is optional, the color background of the circuit board is selected to match the intended hue of the LEDs forming the symbol. In step 604, a light diffuser is coupled to the circuit board. In step 605, which is optional, a power track is provided to couple with at least one circuit board. Processing ends at step 606.

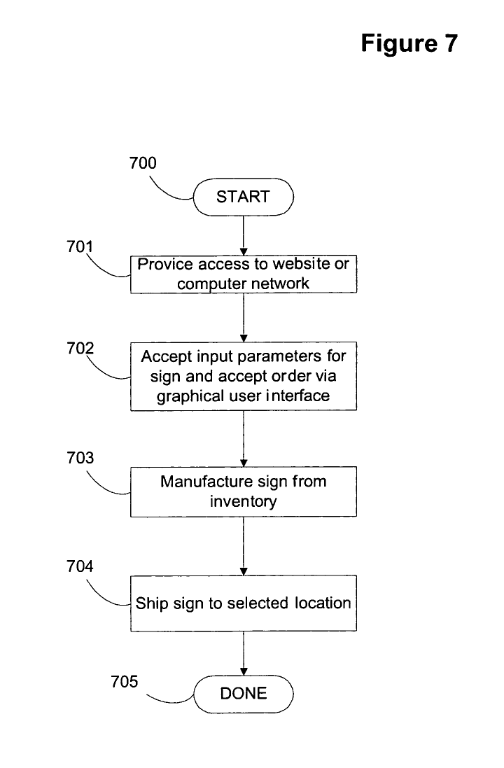

FIG. 7 illustrates another embodiment of the invention that allows a user to create and order custom signs over a computer network, such as the internet. Processing starts at step 700 and in step 701, the system provides access to a website or networked computer. In step 701, the system accepts inputs from a user allowing for his or her parameters for the desired sign to be entered via a graphical user interface, which may include accepting input of any and all pertinent information about the letters, numbers or other symbols that the user desires for his or her sign. The sign may be used for business, personal use or a special event that the user has planned. In the step 702, the system further accepts an order from the user for the sign using the graphical user interface. In step 703, the sign is manufactured pursuant to the order accepted by the system and placed by the user and the sign is manufactured from letters, numbers or symbols that are in inventory. In step 704, the manufactured sign is shipped out to the location accepted by the system and input by the user as indicated for the shipping address, which location may be a business address, residence address or location of a special event that the user has planned. Processing ends at 705

While the invention herein disclosed has been described by means of specific embodiments and applications thereof, numerous modifications and variations could be made thereto by those skilled in the art without departing from the scope of the invention set forth in the claims.

What is claimed is:

1. A light emitting diode symbol block apparatus comprising:
a block comprising a circuit board wherein said block further comprises a power connector and a ground connector;
a light diffuser;
a plurality of LEDs coupled with said circuit board and configured to illuminate in a shape of a symbol wherein said light diffuser is situated on an opposing side of said plurality of LEDs with respect to said circuit board and wherein said light diffuser is configured to diffuse light in order to hide at least one gap between said plurality of LEDs; and,
a power supply coupled with said power connector and said ground connector.

2. The apparatus of claim 1 wherein said circuit board is colored with a background color in said shape of said symbol.

3. The apparatus of claim 1 wherein said circuit board is colored with a background color in said shape of said symbol and wherein said background color comprises a hue of said plurality of said LEDs when said plurality of said LEDs are illuminated.

4. The apparatus of claim 1 wherein said shape of a symbol is selected from the group consisting of character, number, icon and shape.

5. The apparatus of claim 1 further comprising:
a power track;
a ground track;
said power connector configured to couple with said power connector via said power track; and,
said ground connector configured to couple with said ground connector via said ground track.

6. The apparatus of claim 1 wherein said light diffuser is acrylic.

7. The apparatus of claim 1 wherein said light emitting diode sign comprises a layout greater than one dimensional.

8. The apparatus of claim 1 wherein said light emitting diode sign comprises a layout selected from the group consisting of flat and curved.

9. The apparatus of claim 1 wherein said circuit board comprises a setting indicating the pattern of illumination for illuminating said plurality of LEDs on said circuit board.

10. The apparatus of claim 1 wherein said circuit board comprises a setting indicating the pattern of illumination for illuminating a plurality of circuit boards in a pattern or in an order.

11. The apparatus of claim 1 wherein said circuit board comprises a setting indicating the order of illumination for illuminating a plurality of circuit boards in an order.

12. A method for utilizing a light emitting diode symbol block apparatus comprising:
coupling a circuit board to a power connector and a ground connector;
coupling a plurality of LEDs with said circuit board and configured to illuminate in a shape of a symbol;
coupling a light diffuser to an opposing side of said plurality of LEDs with respect to said circuit board and wherein said light diffuser is configured to diffuse light in order to hide at least one gap between said plurality of LEDs.

13. The method of claim 12 further comprising coloring said circuit board with a background color in said shape of said symbol.

14. The method of claim 12 further comprising shaping said symbol in a shape selected from a group consisting of character, number, icon.

15. The method of claim 12 further comprising:
providing a power track configured to couple with said power connector; and,
providing a ground track configured to couple with said ground connector.

16. The method of claim 12 wherein said coupling said light diffuser further comprises coupling an acrylic light diffuser.

17. The method of claim 12 further comprising forming said circuit board and said light diffuser into a layout greater than or equal to two-dimensional.

18. The method of claim 12 further comprising coupling a pattern setting switch to said circuit board for indicating a pattern of illumination for illuminating said plurality of LEDs on said circuit board.

19. The method of claim 12 further comprising providing a pattern selector for selecting a pattern of illumination for illuminating a plurality of circuit boards in a pattern.

20. The method of claim 12 further comprising coupling a order switch to said circuit board for indicating an order of illumination for illuminating a plurality of circuit boards in an order.

21. A method for manufacturing a light emitting diode symbol block apparatus having at least one LED coupled to a circuit board, comprising:
providing access to a website or computer network configured to accept entry of desired parameters;
accepting said desired parameters for a light emitting diode symbol block apparatus via a graphical user interface on a computer;
manufacturing said light emitting diode symbol block apparatus in conformity with said desired parameters; and,
shipping said manufactured light emitting diode apparatus to a selected location.

22. The method of claim 21 further comprising:
providing a power connector and a ground connector adapted to be coupled to said light emitting diode symbol block apparatus.
